(19) United States
(12) Patent Application Publication
(10) Pub. No.: US 2002/0196627 A1
(43) Pub. Date: Dec. 26, 2002

(54) Light beam adjusting device for vehicle head light

(76) Inventor: Jen Hsieh Shin, Chang Hua (TW)

Correspondence Address: Jen Hsieh Shin, 7F, No. 46, Pin Ho 10 Street, Chang Hua, 500, TW

(21) Appl. No.: 09/888,820

(22) Filed: Jun. 22, 2001

(51) Int. Cl. F21V 21/22; F21V 19/02

(52) U.S. Cl. 362/286; 362/526; 362/270; 362/429

(57) ABSTRACT

A light includes a casing for securing to an object, such as the head light housing, a socket slidably received in the casing for supporting a light bulb, and a reflector disposed around the light bulb. The light bulb is a high intensity light bulb that may generate a strong light. A cable is coupled between the socket and a solenoid device, for moving the light bulb relative to the reflector to adjust a light beam of the light device when the solenoid device is energized. A spring may be engaged with the cable for recovering the light bulb relative to the reflector.

### BACKGROUND OF THE INVENTION

1. Field of the Invention

The present invention relates to a vehicle head light apparatus, and more particularly to a vehicle head light apparatus having a light beam adjusting device.

2. Description of the Prior Art

Typical vehicle head lights employ the halogen light bulbs which have a light intensity that is not good enough for lighting purposes during the night. In addition, the typical halogen light bulbs comprise a long and a short light wicks disposed therein and actuated or energized separately for adjusting the light intensities or for adjusting the light beams of the vehicle head lights. The typical halogen light bulbs has a low or bad light intensity when the short light wicks are actuated or energized.

The present invention has arisen to mitigate and/or obviate the afore-described disadvantages of the conventional vehicle head lights.

### SUMMARY OF THE INVENTION

The primary objective of the present invention is to provide a vehicle head light apparatus having a light beam adjusting device for adjusting the light beam by moving the light bulb.

The other objective of the present invention is to provide a vehicle head light apparatus having a light bulb that has a single light wick and that has an increased light intensity.

In accordance with one aspect of the invention, there is provided a light apparatus comprising a casing for attaching to an object, a socket slidably received in the casing, a light bulb attached to the socket, a reflector disposed around the light bulb, and a device provided for moving the light bulb relative to the reflector to adjust a light beam of the light apparatus. The light bulb is preferably a high intensity light bulb that may generate a strong light, and includes a single light wick.

A head light housing is further provided, and a device may secure the casing to the head light housing, and includes at least ear extended from the casing for securing to the head light housing.

The moving device includes a cable coupled to the socket for moving the socket relative to the casing.

The socket includes a block provided thereon and having a cavity formed therein, the cable includes a first end having a head secured thereto and engaged in the cavity of the block.

A device is further provided for recovering the cable and includes a cap secured to the casing and a conduit formed in the cap for threading the cable, and a spring engaged between the cable and the cap for recovering the cable relative to the casing.

The moving device includes a core slidably engaged in a solenoid device and coupled to the cable for moving the cable when the solenoid device is energized. The core includes a first end having a cavity formed therein, the cable includes an enlarged head provided on one end and secured in the cavity of the core, for being actuated by the core and the solenoid device.

A receptacle is further provided for receiving the solenoid device, two electromagnetic members are disposed in the receptacle, and a conductor blade is secured to the core and disposed between the electromagnetic members.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a vehicle head light apparatus in accordance with the present invention;

FIG. 2 is an exploded view of the vehicle head light apparatus;

FIG. 3 is a partial rear perspective view of a casing for receiving the light bulb;

FIG. 4 is a partial rear perspective view of a socket for holding the light bulb;

FIG. 5 is a rear perspective view illustrating the attachment of the vehicle head light apparatus to the head light housing of the vehicle;

FIG. 6 is a partial cross sectional view taken along lines 6-6 of FIG. 5;

FIG. 7 is a partial cross sectional view similar to FIG. 6, illustrating the operation of the vehicle head light apparatus;

FIG. 8 is a partial cross sectional view taken along lines 8-8 of FIG. 1;

FIG. 9 is a partial cross sectional view similar to FIG. 8, illustrating the operation of the vehicle head light apparatus; and

FIG. 10 is a partial plane schematic view illustrating the operation of the vehicle head light apparatus.

### DETAILED DESCRIPTION OF THE PREFERRED EMBODIMENT

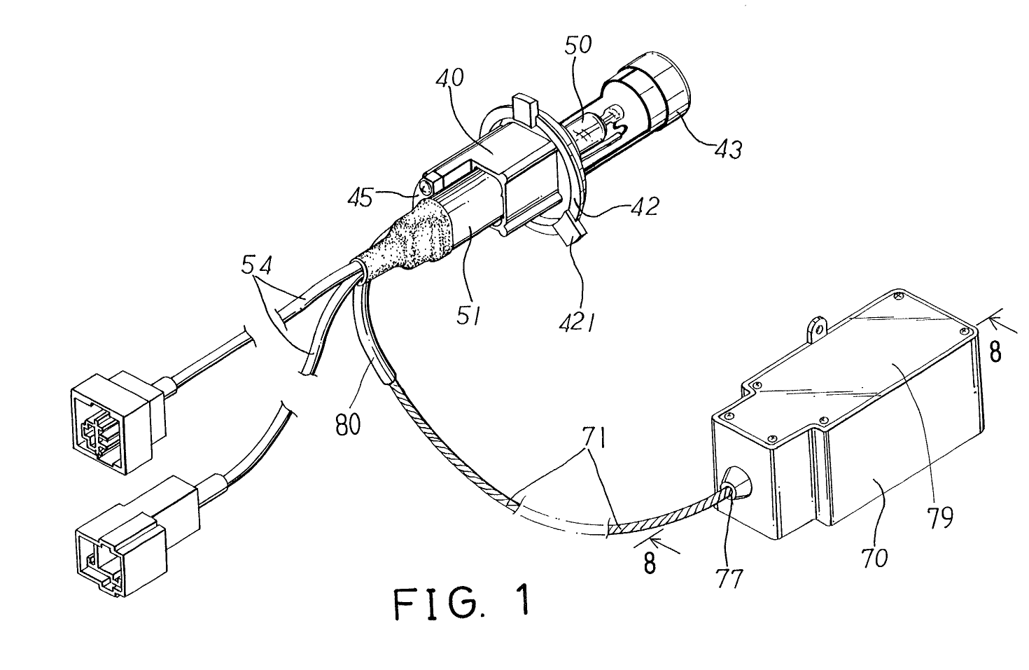

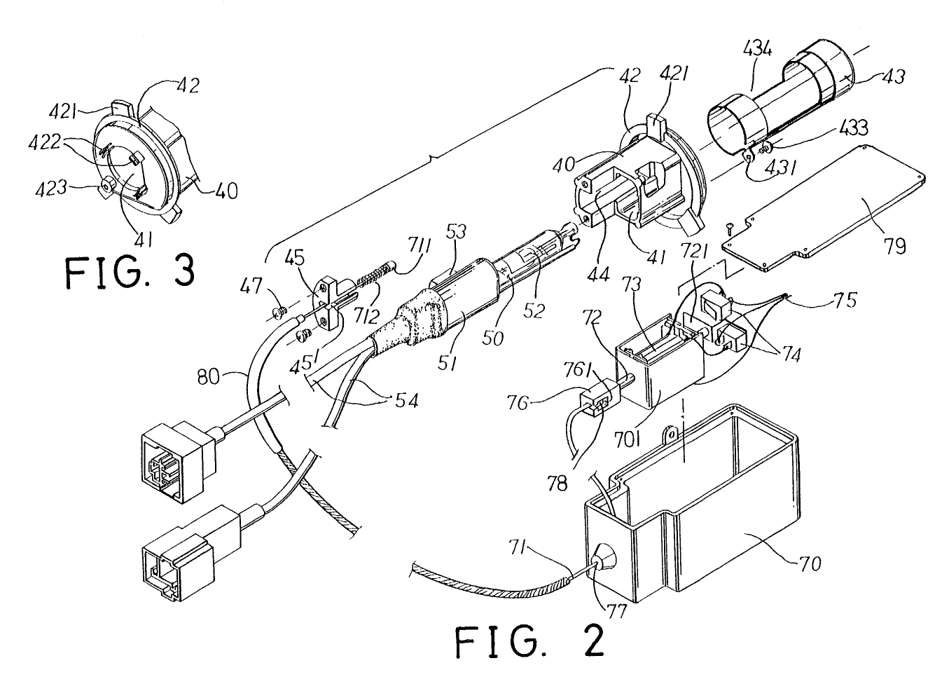

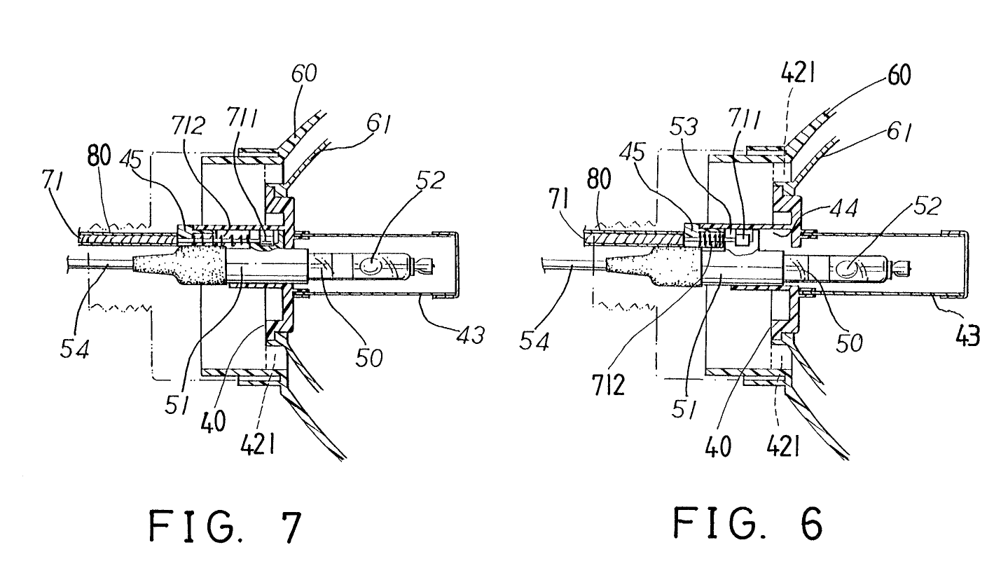

Referring to the drawings, and initially to FIGS. 1-6, a vehicle head light apparatus in accordance with the present invention comprises a casing 40 including a peripheral flange 42 and including one or more ears 421 extended radially outward therefrom or extended outward from the peripheral flange 42 for securing in a vehicle head light housing 60 or the like with fasteners, or by a force-fitted engagement, or with adhesive materials, etc. The casing 40 includes a bore 41 and a channel 44 formed therein and communicating with each other. The casing 40 includes one or more pairs of clamping members 422 and a stud 423 (FIG. 3) extended rearward therefrom. A shield 43 has one end secured or clamped in the clamping members 422 of the casing 40, and includes an ear 431 secured to the stud 423 of the casing 40 with a fastener 433 or the like, and includes an opening 434 formed therein. A reflector 61 (FIGS. 6, 7) is secured in the head light housing 60, or is secured to the casing 40 and disposed around the shield 43.

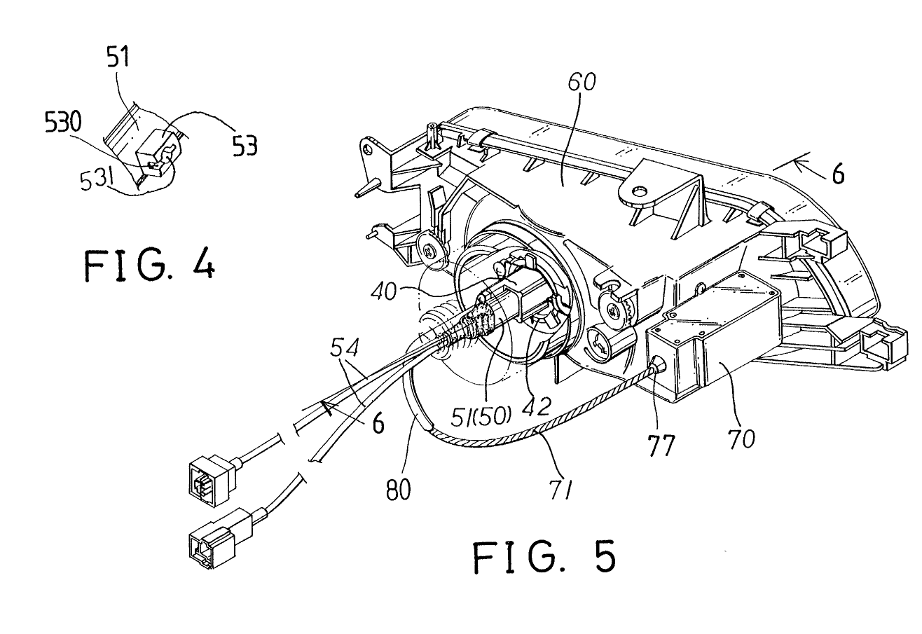

A socket 51 is engaged or received or retained in the bore 41 of the casing 40 and is provided for plugging the light bulb 50 which includes a single light wick 52 and which may be a xenon light bulb or the other high intensity light bulbs and which may be received in the shield 43. The light generated by the light bulb 50 may be lighted or transmitted outward through the opening 434 of the shield 43. The socket 51 includes one or more electric cables or wires 54 for coupling to the electric power source, such as the batteries of the vehicle, which may energize the light bulb 50. The socket 51 includes a block 53 extended laterally outward therefrom (FIG. 4) and having a passage 530 and a cavity 531 formed therein and communicating with each other.

A cap 45 is secured to the end portion of the casing 40 with such as the fasteners 47, and includes a conduit 451 formed therein for threading with a cable 71 or the like therein. One end of the cable 71 is threaded through the conduit 451 of the cap 45 and through the passage 530 of the block 53, and has a head 711 secured thereto and retained in the cavity 531 of the block 53, such that the block 53 and thus the socket 51 and the light bulb 50 may be moved along the bore 41 of the casing 40 and relative to the casing 40 by the cable 71 (FIGS. 6, 7, 10), and such that the light bulb 50 may be moved relative to the reflector 61. A spring 712 is engaged between the head 711 of the cable 71 and the cap 45 for recovering the cable 71 and thus the socket 51 and the light bulb 50 (FIGS. 6, 7).

A receptacle 70 may be secured to the head light housing 60 (FIG. 5) or secured to the other portions of the vehicle, and includes an orifice 77 formed therein for threading with the cable 71. A protective tubular sleeve 80 is preferably engaged onto the cable 71 and engaged between the receptacle 70 and the cap 45. A container 701 is secured in the receptacle 70. A solenoid device 73 is secured in the container 701, and a core 72 is slidably received in the solenoid device 73 and may be actuated or moved relative to the container 701 and the receptacle 70 by the solenoid device 73. The core 72 includes an enlarged head 76 formed or secured to one end thereof and arranged outside the container 701 and having a cavity 761 formed therein for receiving another head 78 that is secured to the other end of the cable 71, such that the socket 51 and thus the light bulb 50 may be pulled or moved by the cable 71 and the core 72 when the solenoid device 73 is energized.

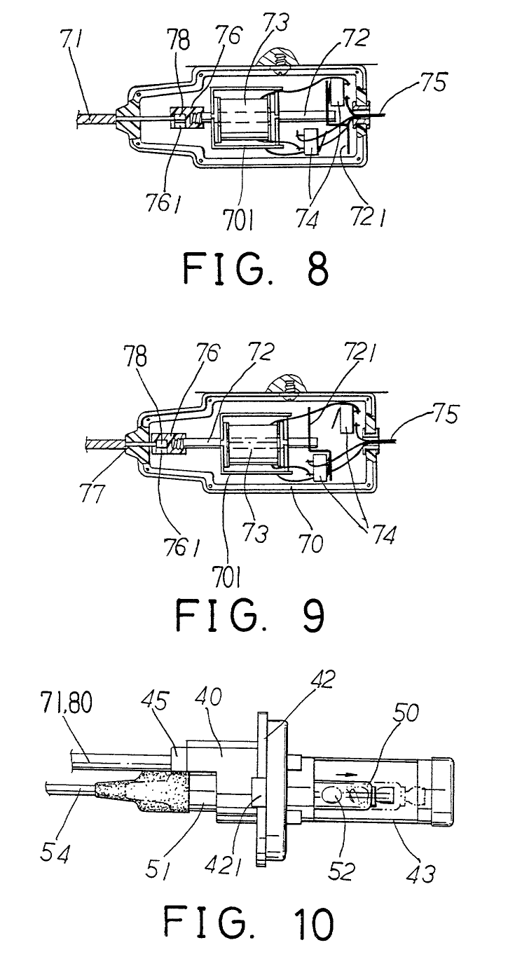

Alternatively, two microswitches or magnets or electromagnetic members 74 are further provided and disposed in the receptacle 70 and electrically coupled to the solenoid device 73 so as to be actuated by the solenoid device 73. The electromagnetic members 74 preferably include different magnetic potentials or magnetic poles. A conductor blade 721 is secured to the other end of the core 72 and disposed between the electromagnetic members 74 and may be attracted or forced toward the selected electromagnetic members 74 when the selected electromagnetic members 74 are energized (FIGS. 8, 9) The electromagnetic members 74 and the solenoid device 73 may be coupled to a processor unit (not shown) with electric wires 75, for actuating the core 72 to move the light bulb 50 relative to the reflector 61 and in order to adjust the light beam of the vehicle head light. A cover 79 may be secured to the receptacle 70 for retaining the solenoid device 73 and the electromagnetic members 74 and the other elements within the receptacle 70. The engagement of the conductor blade 721 with the microswitches (74) may be used to limit the relative movement between the core 72 and the container 701 and the receptacle 70.

In operation, as shown in FIGS. 6-10, the light bulb 50 may be moved relative to the reflector 61 by the solenoid device 73 and/or the electromagnetic members 74, such that the light beam of the vehicle head light may be adjusted. The light bulb 50 may be a xenon light bulb or the other high intensity light bulbs that include a single light wick and that include a great light intensity for generating a strong light.

The light apparatus in accordance with the present invention may be attached to the vehicle head light housing or may be attached to the boats or airplanes or the other vehicles.

Accordingly, the vehicle head light apparatus in accordance with the present invention includes a light beam adjusting device for adjusting the light beam by moving the light bulb that has a single light wick and that has an increased light intensity.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A light apparatus comprising:
a casing for attaching to an object, said casing including a bore formed therein,
a socket slidably received in said bore of said casing,
a light bulb attached to said socket,
a reflector disposed around said light bulb, and
means for moving said light bulb relative to said reflector to adjust a light beam of said light apparatus.

2. The light apparatus according to claim 1 further comprising a head light housing, and means for securing said casing to said head light housing.

3. The light apparatus according to claim 2, wherein said securing means includes at least ear extended from said casing for securing to said head light housing.

4. The light apparatus according to claim 1, wherein said moving means includes a cable coupled to said socket for moving said socket relative to said casing.

5. The light apparatus according to claim 4, wherein said socket includes a block provided thereon and having a cavity formed therein, said cable includes a first end having a head secured thereto and engaged in said cavity of said block.

6. The light apparatus according to claim 5 further comprising means for recovering said cable.

7. The light apparatus according to claim 6, wherein said recovering means includes a cap secured to paid casing and a conduit formed in said cap for threading said cable, and a spring engaged between said cable and said cap for recovering said cable relative to said cap and said casing.

8. The light apparatus according to claim 4, wherein said moving means includes a solenoid device, and a core slidably engaged in said solenoid device and coupled to said cable and operated by said solenoid device in order to move said cable when said solenoid device is energized.

9. The light apparatus according to claim 8, wherein said core includes a first end having a cavity formed therein, said cable includes a first end having an enlarged head provided thereon and secured in said cavity of said core, for allowing said cable to be moved by said core and actuated by said solenoid device.

10. The light apparatus according to claim 8 further comprising a receptacle for receiving said solenoid device, two electromagnetic members disposed in said receptacle, and a conductor blade secured to said core and disposed between said electromagnetic members.
